(19) United States
(12) Patent Application Publication
(10) Pub. No.: US 2025/0376379 A1
(43) Pub. Date: Dec. 11, 2025

(54) LIGHT ENERGY ASSISTED PRODUCTION OF EXPANDED GRAPHITE

(71) Applicant: Khalifa University of Science and Technology, Abu Dhabi (AE)

(72) Inventors: Yarjan Abdul Samad, Abu Dhabi (AE); Shanavas Shajahan, Abu Dhabi (AE); Rami Elkaffas, Abu Dhabi (AE)

(21) Appl. No.: 18/734,902

(22) Filed: Jun. 5, 2024

(51) Int. Cl. C01B 32/225

(52) U.S. Cl. CPC C01B 32/225; C01P 2002/72; C01P 2002/82; C01P 2004/03

(57) ABSTRACT

Provided herein is a method of producing expanded graphite, the method comprising selecting a graphite; intercalating the graphite using an intercalant to produce an intercalated graphite; and irradiating the intercalated graphite with a high energy photon source at a defined wavelength to produce expanded graphite. Also provided herein is a method of producing expanded graphite comprising intercalating flake graphite using an intercalant to produce an intercalated flake graphite; and irradiating the intercalated flake graphite with a high energy photon source at a defined wavelength to produce expanded graphite.

### BACKGROUND

Layered materials represent a diverse and captivating class of substances that exhibit a distinct atomic arrangement. These materials are characterized by their unique structure, where constituent atoms are arranged in discrete layers that are weakly bound together. This layered atomic configuration gives rise to many of intriguing properties, making these materials highly sought after for a wide range of scientific, industrial, and technological applications.

Graphite, a naturally occurring form of crystalline carbon, has long been recognized for its exceptional properties, including high heat and electrical conductivity, chemical resistance, and lubricity. Its layered structure—stacks of two-dimensional sheets held together by van der Waals forces—makes it an ideal material for a broad range of industrial applications.

One particular derivative, thermally expanded graphite (TEG), has been attracting increased attention over the past few years. TEG is produced by heating graphite to very high temperatures in the presence of a chemical intercalation agent. The process causes the graphite to expand, or exfoliate, significantly—up to hundreds of times its original volume—creating a worm-like, porous structure that is lightweight, thermally and electrically conductive, and highly absorbent.

TEG has found numerous uses in a range of industries, from energy (e.g., as an electrode material in batteries and supercapacitors) to environmental engineering (e.g., for oil-spill cleanup and water treatment) to electronics (e.g., for thermal management in electronic devices).

The method for producing TEG typically involves two main steps: intercalation and heating process. In the intercalation step, graphite is treated with an intercalation. This compound penetrates the layers of graphite and forms stable compounds known as graphite intercalation compounds (GICs).

In the heating step, the GICs are rapidly heated to high temperatures via either thermally assisted expiation (around 800-1000° C.) or microwave assisted expansion of a power rate (350 to 1000 watt), causing the intercalated compounds to decompose and release gases. The gas pressure forces the graphite layers apart, leading to a significant expansion in volume. The end product, TEG, is a highly porous material with a distinct worm-like structure. Here, we present an innovative and energy-efficient approach to producing expanded graphite (EG) by utilizing the energy from light source.

### BRIEF SUMMARY

Provided herein is a method of producing expanded graphite, the method comprising selecting a graphite; intercalating the graphite using an intercalant to produce an intercalated graphite; and irradiating the intercalated graphite with a high energy photon source at a defined wavelength to produce expanded graphite.

In some aspects, the expanded graphite measures over 200 times the original volume of the selected graphite. In some aspects, the expanded graphite is a porous material. In some aspects, the graphite is an amorphous graphite, a flake graphite, a crystalline vein graphite, or combinations thereof. In some aspects, the graphite is flake graphite. In some aspects, the flake graphite has a lateral size of about 600 μm.

In some aspects, the intercalant is an alkali metal, sulfate, nitrate, an organic acid, an inorganic acid, a metal halide, a strong acid, or combinations thereof. In some aspects, the intercalant is a strong acid. In some aspects, the strong acid is perchloric acid.

In some aspects, the high energy photon source is an LED light source, a laser or solar energy. In some aspects, the high energy photon source has an output from 2 W to 5 W. In some aspects, the defined wavelength is from 400 nm to 600 nm. In some aspects, the laser is a gas laser or a metal-vapor laser. In some aspects, the gas laser is a helium-neon laser, an argon laser, a krypton laser, a xenon laser, or a nitrogen laser. In some aspects, the metal-vapor laser is a helium-cadmium metal-vapor laser, a helium-mercury metal-vapor laser, helium-selenium metal-vapor laser, strontium vapor laser, coper vapor laser, gold vapor laser, or a manganese vapor laser.

The details of one or more embodiments are set forth in the drawings and the description below. Other features, objects, and advantages will be apparent from the description and drawings, and from the claims.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1A: Shows a scanning electron microscopy (SEM) image of light expanded graphite flakes zoomed in to a scale of 500 μm in accordance with embodiments of the disclosure.

FIG. 1B: Shows a scanning electron microscopy (SEM) image of light expanded graphite flakes zoomed in to a scale of 100 μm in accordance with embodiments of the disclosure.

FIG. 1C: Shows a scanning electron microscopy (SEM) image of solar expanded graphite flakes zoomed in to a scale of 500 μm in accordance with embodiments of the disclosure.

FIG. 1D: Shows a scanning electron microscopy (SEM) image of solar expanded graphite flakes zoomed in to a scale of 100 μm in accordance with embodiments of the disclosure.

FIG. 2A: Shows a Raman spectroscopy plot of laser expanded graphite.

FIG. 2B: Shows a Raman spectroscopy plot of solar expanded graphite in accordance with embodiments of the disclosure.

FIG. 3A: Shows an X-Ray powder diffraction (XRD) graph of intercalated graphite in accordance with embodiments of the disclosure.

FIG. 3B: Shows an X-Ray powder diffraction (XRD) graph of solar expanded graphite in accordance with embodiments of the disclosure.

### DETAILED DESCRIPTION

Before the present disclosure is described in detail, it is to be understood that the terminology used herein is for purposes of describing particular examples and embodiments only, and is not intended to be limiting.

In this specification and in the claims that follow, reference will be made to a number of terms that shall be defined to have the following meanings:

As used herein, the terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Unless defined otherwise, all technical and scientific terms used herein have the same meaning as commonly understood by one of ordinary skill in the art to which this invention belongs. Although, any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

The present disclosure is directed to a method of producing expanded graphite. The method of producing expanded graphite comprises selecting a graphite, intercalating the graphite using an intercalant to produce an intercalated graphite, and irradiating the intercalated graphite with a high energy photon source at a defined wavelength to produce expanded graphite.

In some aspects, the expanded graphite is prepared by intercalating graphite using an intercalant. In some aspects the intercalating step is done by reacting the intercalant with the graphite at a specified ratio. In some aspects, the intercalant is an alkali metal, sulfate, nitrate, an organic acid, an inorganic acid, a metal halide, a strong acid. In some aspects, the specified ratio of graphite to intercalant is at least 1:2, at least 1:3, at least 1:4, at least 1:5, at least 1:6, at least 1:7, or at least 1:8. In some aspects, the intercalant is a strong acid. In some aspects the intercalated graphite is then exposed to a high energy photon source. In some aspects, the high energy photon source is an LED light source, a laser, or solar energy. In some aspects, the irradiation with the high energy photon source produces the expanded graphite.

In some aspects, the expanded graphite measures over 200 times the original volume of the selected graphite. In some aspects, the expanded graphite measures at least 100 times, at least 125 times, at least 150 times, at least 175 times, at least 200 times, at least 225 times, at least 250 times, at least 275 times, at least 300 times, at least 325 times, at least 350 times, at least 375 times, at least 400 times, at least 425 times, at least 450 times, at least 475 times, or at least 500 times the original volume of the selected graphite. In terms of ranges, the expanded graphite measures from 50 to 150, from 100 to 200, from 150 to 250, from 200 to 300, from 250 to 350, from 300 to 400, from 350 to 450, or from 400 to 500 times the original volume of the selected graphite.

In some aspects, the expanded graphite is a porous material. In some aspects, the graphite is an amorphous graphite, a flake graphite, a crystalline vein graphite, or combinations thereof. In some aspects, the graphite is flake graphite. In some aspects, the graphite has a lateral size of at least 100 μm, at least 150 μm, at least 200 μm, at least 250 μm, at least 300 μm, at least 350 μm, at least 400 μm, at least 450 μm, at least 500 μm, at least 550 μm, at least 600 μm, at least 650 μm, at least 700 μm, at least 750 μm, at least 800 μm, at least 850 μm, at least 900 μm, or at least 950 μm. In some aspects, the graphite has a lateral size of 1000 μm or less, of 950 μm or less, of 900 μm or less, of 850 μm or less, of 800 μm or less, of 750 μm or less, of 700 μm or less, of 650 μm or less, of 600 μm or less, of 550 μm or less, of 500 μm or less, of 450 μm or less, of 400 μm or less, of 350 μm or less, of 300 μm or less, of 250 μm or less, or 200 μm or less, or of 150 μm or less. In terms of ranges, the graphite has a lateral size ranging from 100 μm to 1000 μm, from 150 μm to 1000 μm, from 200 μm to 1000 μm, from 250 μm to 1000 μm, from 300 μm to 1000 μm, from 350 μm to 1000 μm, from 400 μm to 1000 μm, from 450 μm to 1000 μm, from 500 μm to 1000 μm, from 550 μm to 1000 μm, from 600 μm to 1000 μm, from 650 μm to 1000 μm, from 700 μm to 1000 μm, from 750 μm to 1000 μm, from 800 μm to 1000 μm, from 850 μm to 1000 μm, from 900 μm to 1000 μm, or from 850 μm to 1000 μm.

In some aspects, the intercalant is an alkali metal, sulfate, nitrate, an organic acid, a metal halide, a strong acid, or combinations thereof. In some aspects, the alkali metal intercalant compound is metal carbides, metal nitrides, metal borides, metal dichalcogenides, or combinations thereof. In some aspects, the intercalant is a metal halide. In some aspects, the metal halide is bromine, sodium chloride, chlorine, fluorine, lithium chloride, potassium iodide, iodine, aluminum bromide, astatine, caesium chloride, caesium fluoride, caesium halides, or combinations thereof. In some aspects, the intercalant is a strong acid. In some aspects, the strong acid is perchloric acid. In some aspects, the strong acid is chloric acid, hydrobromic acid, hydrochloric acid, hydroiodic acid, nitric acid, perchloric acid, sulfuric acid, or combinations thereof. In some aspects, the intercalant is an organic acid. In some aspects the organic acid is acetic acid, formic acid, oxalic acid, tartaric acid, benzoic acid, butyric acid, citric acid, lactic acid, arachidic acid, malic acid, propionic acid, ascorbic acid, uric acid, heptanoic acid, or combinations thereof. In some aspects, the intercalant is K₂S₂O₈, H₃PO₄, (CH₃CO)₂O, HNO₃, H₂O₂, KMnO₄, H₂SO₄, HClO₄, SO₃, (NH₄)₂S₂O₈, or combinations thereof. In some aspects, the intercalant is a lithium, sodium, magnesium, or potassium ion salt, or combinations thereof.

In some aspects, the high energy photon source is an LED light source, a laser or solar energy. In some aspects, the high energy photon source has an output from at least 2.0 W, at least 2.1 W, at least 2.2 W, at least 2.3 W, at least 2.4 W, at least 2.5 W, at least 2.6 W, at least 2.7 W, at least 2.8 W, at least 2.9 W, at least 3.0 W, at least 3.1 W, at least 3.2 W, at least 3.3 W, at least 3.4 W, at least 3.5 W, at least 3.6 W, at least 3.7 W, at least 3.8 W, at least 3.9 W, at least 4.0 W, at least 4.1 W, at least 4.2 W, at least 4.3 W, at least 4.4 W, at least 4.5 W, at least 4.6 W, at least 4.7 W, at least 4.8 W, at least 4.9 W or at lease 5.0 W. In some aspects, the high energy photon source has an output of 5.0 W or less, of 4.9 W or less, of 4.8 W or less, of 4.7 W or less, of 4.6 W or less, of 4.5 W or less, of 4.4 W or less, of 4.3 W or less, of 4.2 W or less, of 4.1 W or less, of 4.0 W or less, of 3.9 W or less, of 3.8 W or less, of 3.7 W or less, of 3.6 W or less, of 3.5 W or less, of 3.4 W or less, of 3.3 W or less, of 3.2 W or less, of 3.1 W or less, of 3.0 W or less, of 2.9 W or less, of 2.8 W or less, of 2.7 W or less, of 2.6 W or less, of 2.5 W or less, of 2.4 W or less, of 2.3 W or less, of 2.2 W or less, of 2.1 W or less, or of 2.0 W or less. In terms of ranges, the high photon source has an output from 1.0 W to 1.2 W, from 1.1 W to 1.3 W, from 1.2 W to 1.4 W, from 1.3 W to 1.5 W, from 1.4 W to 1.6 W, from 1.5 W to 1.7 W, from 1.6 W to 1.8 W, from 1.7 W to 1.9 W, from 1.8 W to 2.0 W, from 1.9 W to 2.1 W, from 2.0 W to 2.2 W, from 2.1 W to 2.3 W, from 2.2 W to 2.4 W, from 2.5 W to 2.7 W, from 2.6 W to 2.8 W, from 2.7 W to 2.9 W, from 2.8 W to 3.0 W, from 2.9 W to 3.1 W, from 3.0 W to 3.2 W, from 3.1 W to 3.3 W, from 3.2 W to 3.4 W, from 3.3 W to 3.5 W, from 3.4 W to 3.6 W, from 3.5 W to 3.7 W, from 3.6 W to 3.8 W, from 3.7 W to 3.9 W, from 3.8 W to 4.0 W, from 3.9 W to 4.1 W, from 4.0 W to 4.2 W, from 4.1 W to 4.3 W, from 4.2 W to 4.4 W, from 4.3 W to 4.5 W, from 4.4 W to 4.6 W, from 4.5 W to 4.7 W, from 4.6 W to 4.8 W, from 4.7 W to 4.9 W, from 4.8 W to 5.0 W, from 4.9 W to 5.1 W, from 5.0 W to 5.2 W, from 5.1 W to 5.3 W, from 5.2 W to 5.4 W, from 5.3 W to 5.5 W, from 5.4 W to 5.6 W, from 5.5 W to 5.7 W, from 5.6 W to 5.8 W, from 5.7 W to 5.9 W, or from 5.8 W to 6.0 W.

In some aspects, the defined wavelength is from at least 400 nm, from at least 450 nm, from at least 500 nm, from at least 550 nm, or from at least 600 nm. IN some aspects, the defined wavelength is of 600 nm or less, of 550 nm or less, of 500 nm or less, of 450 nm or less, of 400 nm or less. In terms of ranges, the defined wavelength is from 300 nm to 400 nm, from 350 nm to 450 nm, from 400 nm to 500 nm, from 450 nm to 550 nm, from 500 nm to 600 nm, from 550 nm to 650 nm, or from 600 nm to 700 nm. In some aspects, the defined wavelength is 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, or 700 nm.

In some aspects, the laser is a gas laser or a metal-vapor laser. In some aspects, the gas laser is a helium-neon laser, an argon laser, a krypton laser, a xenon laser, or a nitrogen laser. In some aspects, the metal-vapor laser is a helium-cadmium metal-vapor laser, a helium-mercury metal-vapor laser, helium-selenium metal-vapor laser, strontium vapor laser, coper vapor laser, gold vapor laser, or a manganese vapor laser.

Aspects of the disclosure and the invention may be further understood by reference to the following no-limiting examples.

### EXEMPLARY EMBODIMENTS

Exemplary embodiments provided in accordance with the presently disclosed subject matter include, but are not limited to, the claims and the following embodiments:

Embodiment 1: A method of producing expanded graphite, the method comprising, selecting a graphite, intercalating the graphite using an intercalant to produce an intercalated graphite, and irradiating the intercalated graphite with a high energy photon source at a defined wavelength to produce expanded graphite.

Embodiment 2: The method of embodiment 1, wherein the expanded graphite measures over 200 times the original volume of the selected graphite.

Embodiment 3: The method of embodiments 1 or 2, wherein the expanded graphite is a porous material.

Embodiment 4: The method of any one of embodiments 1-3, wherein the graphite is an amorphous graphite, a flake graphite, a crystalline vein graphite, or combinations thereof.

Embodiment 5: The method of any one of embodiments 1-4, wherein the graphite is flake graphite.

Embodiment 6: The method of embodiment 5, wherein the flake graphite has a lateral size of about 600 μm.

Embodiment 7: The method of any one of embodiments 1-6, wherein the intercalant is an alkali metal, sulfate, nitrate, an organic acid, an inorganic acid, a metal halide, a strong acid, or combinations thereof.

Embodiment 8: The method of any one of claims embodiment 1-7, wherein the intercalant is a strong acid.

Embodiment 9: The method of embodiment 8, wherein the strong acid is perchloric acid.

Embodiment 10: The method of any one of embodiments 1-9, wherein the high energy photon source is an LED light source, a laser or solar energy.

Embodiment 11: The method of any one of embodiments 1-10, wherein the high energy photon source has an output from 2 W to 5 W.

Embodiment 12: The method of any one of embodiments embodiment 1-11, wherein the defined wavelength is from 400 nm to 600 nm.

Embodiment 13: The method of embodiment 10, wherein the laser is a gas laser or a metal-vapor laser.

Embodiment 14: The method of embodiment 13, wherein the gas laser is a helium-neon laser, an argon laser, a krypton laser, a xenon laser, or a nitrogen laser.

Embodiment 15: The method of embodiment 13, wherein the metal-vapor laser is a helium-cadmium metal-vapor laser, a helium-mercury metal-vapor laser, helium-selenium metal-vapor laser, strontium vapor laser, coper vapor laser, gold vapor laser, or a manganese vapor laser.

Embodiment 16: A method of producing expanded graphite, the method comprising: intercalating flake graphite using an intercalant to produce an intercalated flake graphite; and irradiating the intercalated flake graphite with a high energy photon source at a defined wavelength to produce expanded graphite.

Embodiment 17: The method of embodiment 16, wherein the high energy photon source is an LED light source, a laser or solar energy. Embodiment 18: The method of embodiment 16 or 17, wherein the flake graphite has a lateral size of about 600 μm.

Embodiment 19: The method of any one of embodiments 16-18, wherein the intercalant is a strong acid.

Embodiment 20: The method of embodiment 19, wherein the strong acid is perchloric acid.

### EXAMPLES

### Example 1: Materials and Methods

Preparation of Intercalated Graphite: Graphite and perchloric acid were reacted in the ratio of (graphite: perchloric acid; 1:4) at 150° C. for 30 min to form an intercalated graphite compound.

Preparation of Laser Expanded Graphite: Laser expanded graphite was prepared by taking the intercalated graphite in the ceramic dish and illuminating it with a continuous wave infrared (CW-IR) laser source for 30 sec at a distance of 2 cm.

Preparation of Solar Expanded Graphite: Solar expanded graphite was prepared by irradiating focused solar radiation on the intercalated graphite. The solar radiation was focused using simple magnification glass with diameter and focal length of about 7.5 cm and 10 cm, respectively. Not intending to be bound by theory, the focused solar irradiation on intercalated graphite triggers the rapid expansion process to form solar expanded graphite.

### Example 2: Scanning Electron Microscopy

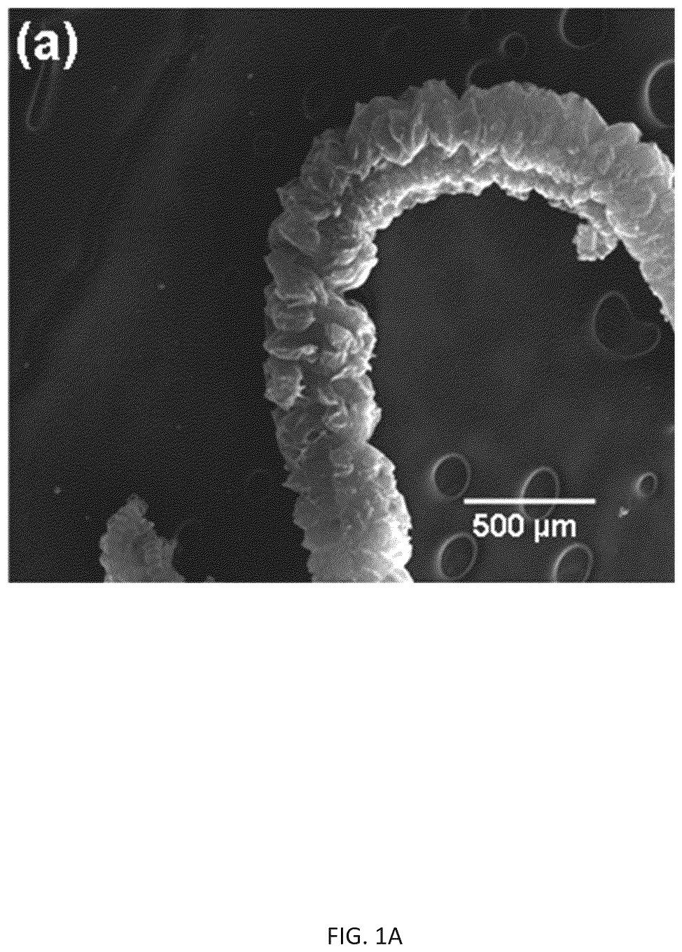

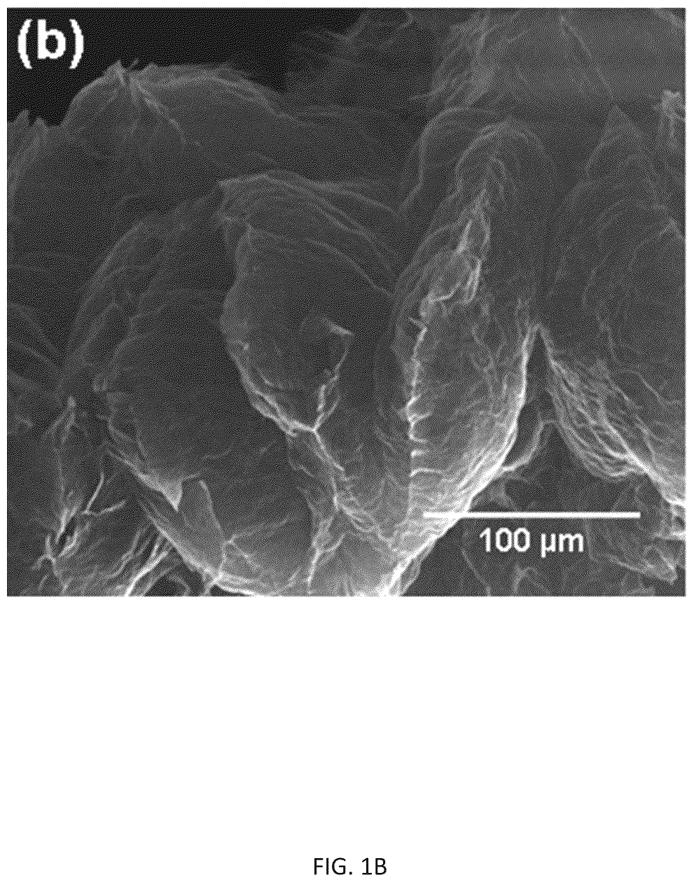

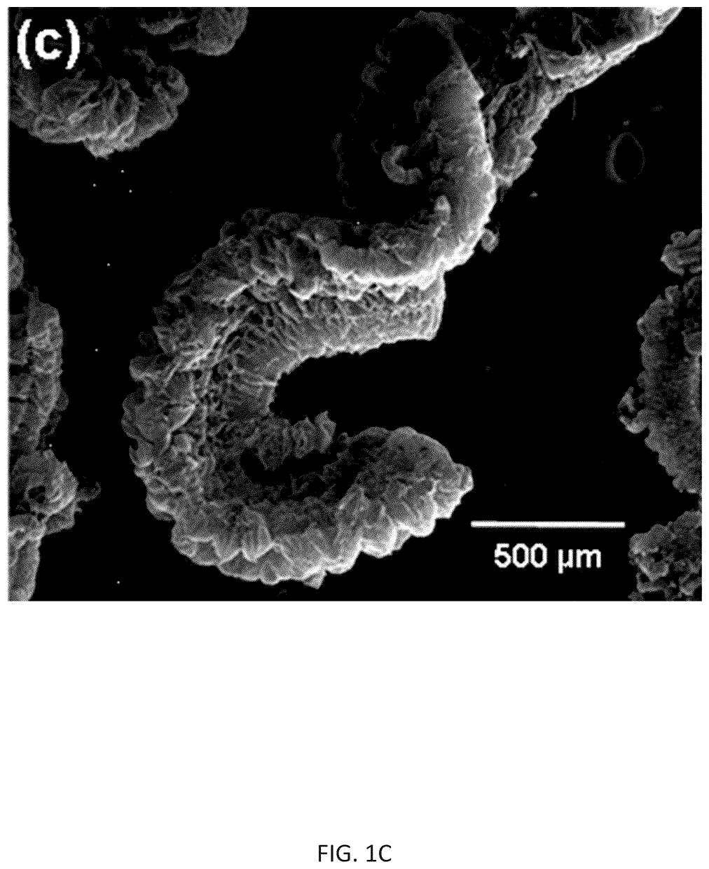

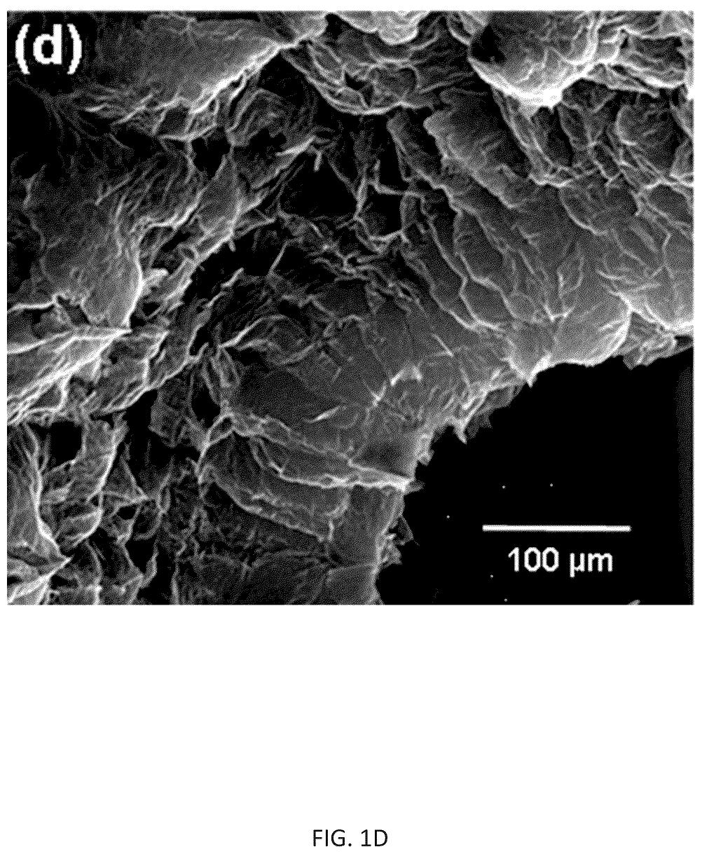

The observed SEM images (FIGS. 1A-D) show an expansion of graphite flakes into a scaled worm like morphology. The SEM data shows that proper and efficient expansion of graphite flakes through high energy photon irradiation from laser and solar source was achieved. The volume of expanded graphite was measured as 240 times that of the original volume of graphite flakes. This expansion led to the formation of “scaled worm-like” structure by creating space between the layers of graphite flakes.

### Example 3: Raman Spectroscopy

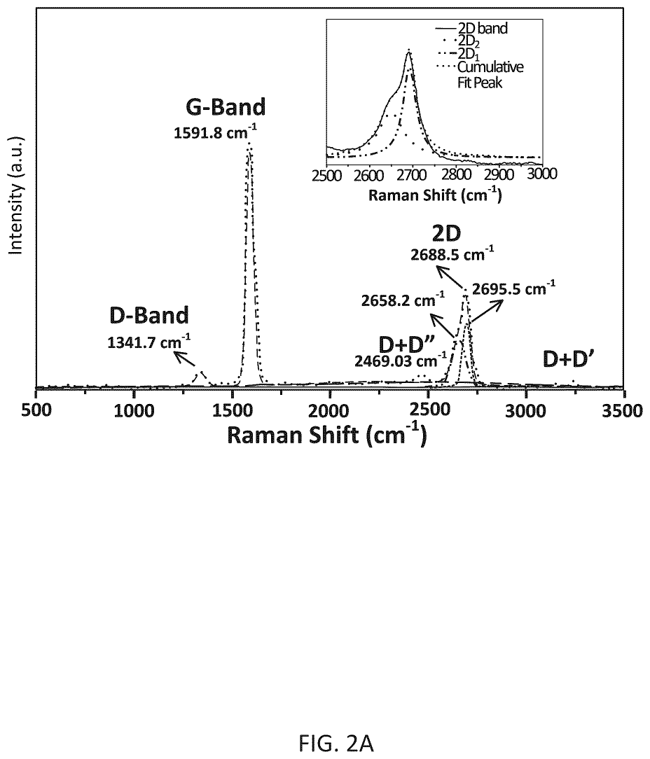

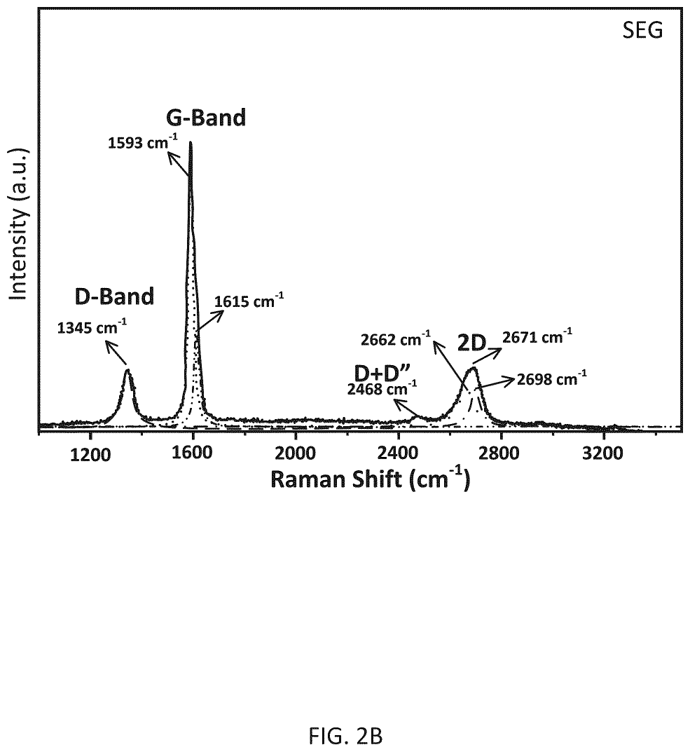

The Raman spectrum of laser expanded graphite (LEG) and solar expanded graphite (SEG) is shown in FIGS. 2A-B. Both LEG and SEG samples demonstrate distinct characteristic D, G and 2D peaks. The strong peak at 1591.8 cm⁻¹ in LEG and 1593 cm⁻¹ in SEG corresponds to the G band which is responsible for the C-C in plane stretching in the sp² hybridized carbon atom of expanded graphite structure. The D+D″ (2468 cm⁻¹) band appear due to the excitation of two phonons with opposite momenta, which promote these disorder-induced (DI) Raman bands (FIG. 2A—laser expanded graphite). In FIG. 2B, for solar expanded graphite, the fitting of the 2D bands, gives two deconvolution peaks, 2D₁ and 2D₂ at 2698 cm⁻¹ and 2662 cm⁻¹, respectively. The 2D band is an overtone mode of the D band, it appears in the second-order Raman spectra of crystalline graphite, and it does not need defects to be activated.

### Example 3: XRD Spectroscopy

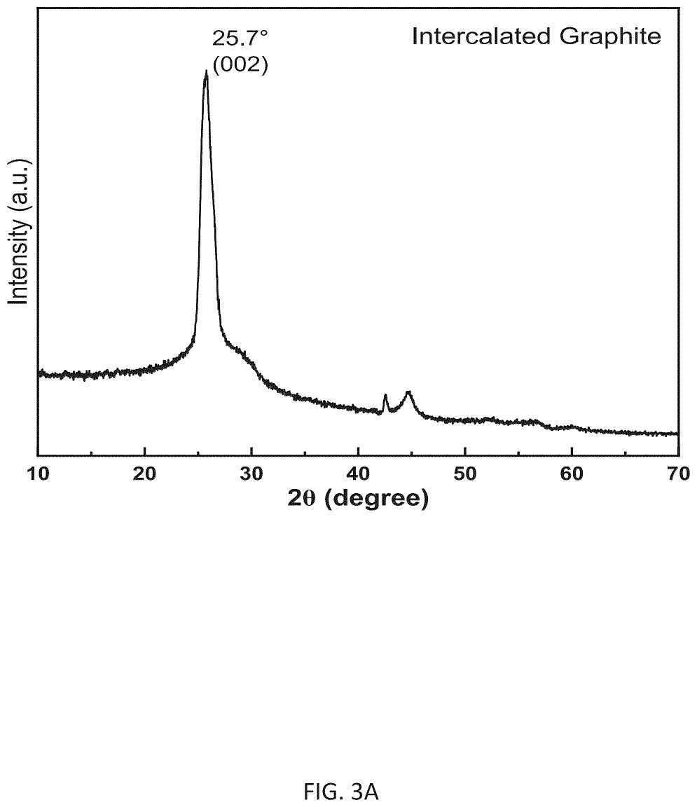

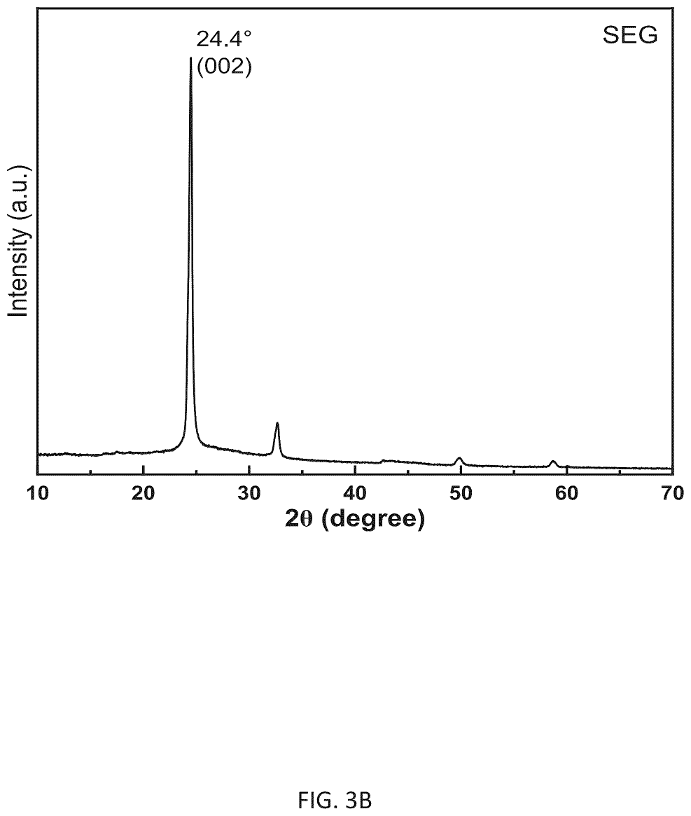

The X-Ray powder diffraction (XRD) patterns of intercalated graphite (IG) and solar-expanded graphite (SEG) are shown in FIGS. 3A-B, respectively. The intercalation stage of intercalated graphite can be determined using a change in inter-lattice distance between layers of graphene sheets. The inter-lattice spacing in the IG sample was determined to be 7.80 Å. Not intending to be bound by theory, this further suggests stage-II intercalation of HClO₄ in graphite lattice. The shift of peak towards lower diffraction angle is observed in SEG when compared with IG, which suggests the successful expansion process.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by examples, embodiments, and optional features, modification and variation of the concepts herein disclosed may be resorted to by those skilled in the art, and that such modifications and variations are considered to be within the scope of this invention as defined by the appended claims.

1. A method of producing expanded graphite, the method comprising:
selecting a graphite;
intercalating the graphite using an intercalant to produce an intercalated graphite; and
irradiating the intercalated graphite with a high energy photon source at a defined wavelength to produce expanded graphite.

2. The method of claim 1, wherein the expanded graphite measures over 200 times the original volume of the selected graphite.

3. The method of claim 1, wherein the expanded graphite is a porous material.

4. The method of claim 1, wherein the graphite is an amorphous graphite, a flake graphite, a crystalline vein graphite, or combinations thereof.

5. The method of claim 1, wherein the graphite is flake graphite.

6. The method of claim 5, wherein the flake graphite has a lateral size of about 600 μm.

7. The method of claim 1, wherein the intercalant is an alkali metal, sulfate, nitrate, an organic acid, an inorganic acid, a metal halide, a strong acid, or combinations thereof.

8. The method of claim 1, wherein the intercalant is a strong acid.

9. The method of claim 8, wherein the strong acid is perchloric acid.

10. The method of claim 1, wherein the high energy photon source is an LED light source, a laser or solar energy.

11. The method of claim 1, wherein the high energy photon source has an output from 2 W to 5 W.

12. The method of claim 1, wherein the defined wavelength is from 400 nm to 600 nm.

13. The method of claim 10, wherein the laser is a gas laser or a metal-vapor laser.

14. The method of claim 13, wherein the gas laser is a helium-neon laser, an argon laser, a krypton laser, a xenon laser, or a nitrogen laser.

15. The method of claim 13, wherein the metal-vapor laser is a helium-cadmium metal-vapor laser, a helium-mercury metal-vapor laser, helium-selenium metal-vapor laser, strontium vapor laser, coper vapor laser, gold vapor laser, or a manganese vapor laser.

16. A method of producing expanded graphite, the method comprising:
intercalating flake graphite using an intercalant to produce an intercalated flake graphite; and
irradiating the intercalated flake graphite with a high energy photon source at a defined wavelength to produce expanded graphite.

17. The method of claim 16, wherein the high energy photon source is an LED light source, a laser or solar energy.

18. The method of claim 16, wherein the flake graphite has a lateral size of about 600 μm.

19. The method of claim 16, wherein the intercalant is a strong acid.

20. The method of claim 19, wherein the strong acid is perchloric acid.
